(19) United States
(12) Patent Application Publication
(10) Pub. No.: US 2025/0326473 A1
(43) Pub. Date: Oct. 23, 2025

(54) SAFETY SHUT-OFF APPARATUS FOR A PLATFORM BOAT LIFT

(71) Applicant: William Golden, North Fort Myers, FL (US)

(72) Inventor: William Golden, North Fort Myers, FL (US)

(21) Appl. No.: 19/073,530

(22) Filed: Mar. 7, 2025

Related U.S. Application Data
(60) Provisional application No. 63/562,507, filed on Mar. 7, 2024.

(51) Int. Cl. B63C 3/00; B66F 7/02; B66F 11/00

(52) U.S. Cl. CPC B63C 3/00; B66F 7/02; B66F 11/00; B66F 2700/123

(57) ABSTRACT

A platform boat lift safety shut-off apparatus includes a flexible safety cable supported below the fixed deck of the lift and operatively connected to the motor or other drive system of the lift through a shut-off switch. The cable is assembled and positioned such that during elevation of the lift platform, the body part of a person extending over an edge of the platform engages the cable and exerts a force on the cable, which operates the switch to deactivate the drive system and stop elevation of the platform before the platform reaches the level of the fixed deck.

### FIELD OF THE INVENTION

This invention relates to a safety shut-off apparatus for automatically stopping the lifting operation of a platform boat lift when a dangerous, unsafe, or emergency condition is detected.

### BACKGROUND OF THE INVENTION

Platform boat lifts typically employ a fixed deck or dock and an operatively connected lift platform that supports a boat or other marine vessel. The lift platform and supported vessel are selectively raised and lowered by various types of lift mechanisms, which are conventionally employed in the boat lift industry. The lift platform is typically constructed to be in close tolerance with the adjoining deck when the platform is in an elevated or raised condition. This can create an extremely dangerous situation when a person is seated or otherwise positioned on the platform such that his or her legs and/or arms dangle or otherwise extend over the edge of the platform while it is being raised. If that person is distracted or inattentive, one or more of their limbs may be caught between the rising platform and adjoining fixed deck. This can cause severe and potentially catastrophic injury.

### SUMMARY OF THE INVENTION

It is therefore an object of the present invention to provide a platform lift safety apparatus that reduces the risk that a person will be accidentally caught or trapped between the lift platform and adjoining deck or dock when the platform is being raised.

It is a further object of this invention to provide a platform lift emergency shut-off apparatus for automatically stopping elevation of the lift when a person is dangerously seated or otherwise positioned on an edge of the lift platform and before the lift platform reaches the level of the fixed deck.

It is a further object of this invention to provide a platform lift safety shut-off apparatus that significantly reduces the risk of a person being caught or trapped between the moving platform and fixed deck of the lift and suffering serious injury.

It is a further object of this invention to provide a platform lift safety shut-off apparatus that may be utilized by platform lifts employing various types of lift operating mechanisms including, but not limited to motor driven winder and cable assemblies, hydraulic systems, and gear driven systems.

It is a further object of this invention to provide an emergency shut-off apparatus for a platform lift that prevents the lift platform from rising to the level of the adjoining fixed lift deck when a person is seated or otherwise located proximate an edge of the platform adjacent to an edge of the deck.

This invention features a safety shut-off apparatus for a platform boat lift, which lift includes a fixed deck or dock (hereinafter “deck”) mounted in a body of water and a lift platform operably mounted to the deck for supporting a boat or other marine vessel (hereinafter “boat”). A motor-driven winder and cable system or other lift operating mechanism selectively raises and lowers the platform relative to the deck. The safety shut-off apparatus includes a safety shut-off switch attached to the deck and a switch actuating sensor is operably connected to the shut-off switch. When the lift platform is being raised by the lift mechanism, the sensor responds to detecting the presence of a person or other object on the lift platform projecting laterally outwardly from the platform and underneath the deck by actuating the safety shut-off switch to deactivate the lift operating mechanism and stop further elevation of the lift platform such that a top surface of the lift platform is held below and spaced apart from a bottom surface of the deck.

In a preferred embodiment, when the lift operating mechanism is raising the lift platform, the switch actuating sensor responds to detection of a predetermined upward force being applied thereto by actuating the safety shut-off switch to deactivate the lift operating mechanism and stop further elevation of the platform. The switch actuating sensor may include a flexible line such as a safety cable, wire or other elongate element that is proximate to and extends longitudinally along and below an edge of the fixed deck that generally conformably abuts a corresponding edge of the platform when the platform is in a raised or elevated condition relative to the fixed deck. The fixed deck may include a recess that receives and conformably abuts a peripheral edge of the lift platform when the lift platform is fully elevated. The fixed deck may be supported above the body of water by a plurality of pilings. The elongate switch actuating sensor element may be longitudinally movably connected to and extend between the pilings beneath an upper surface of the fixed deck and proximate the recess of the fixed deck.

The lift platform may be selectively raised and lowered by one or more motor-driven winder mechanisms and attached lift cables. The safety shut-off switch may be mounted to the deck and operably connected to the motor that controls a respective winder. In alternative embodiments, the shut-off switch may be operably connected to other lift operating mechanisms (e.g. hydraulic) for selectively raising and lowering the platform. In each case, application of a selected tension or force to the sensor element or other impingement of the sensor by a person or other object on the top surface of the platform and extending beyond the deck-abutting edge of the platform actuates the shut-off switch to, in turn, stop further upward movement of the platform relative to the deck. The cable or other flexible line is positioned below the deck so that there is a sufficiently wide gap between the platform and deck to minimize the risk of a person seated on an edge of the platform being pinched, trapped or caught between the fixed deck and rising platform.

In alternative embodiments, the force activated sensor may be replaced by alternative switch actuating sensors such as a photoelectric detector mounted to the deck and employing an optical beam positioned and oriented analogously to the flexible line sensor. When the lift platform is being raised and a person or other object on the platform projects laterally outwardly from the an edge of the platform and underneath the deck, that person or object will interrupt the optical beam at a predetermined distance below the deck, which, in turn, will actuate the shut-off switch and stop the lift operating mechanism from raising the lift platform further.

### BRIEF DESCRIPTION OF THE DRAWINGS

FIG. 1 is a simplified perspective view of the platform lift safety shut-off apparatus of this invention and particularly illustrates a preferred safety cable configuration used when the lift features a winder driven lift operating or drive mechanism. The safety cable extends along the peripheral edge of a recess in the deck that conformably accommodates the platform when the lift is in an elevated or raised condition.

FIG. 2 is a simplified and partly schematic side view of the lefthand side of the platform lift employing the preferred safety shut-off apparatus of this invention. The flexible safety cable is shown interconnected to an extending between the safety shut-off switch and a first one of the deck supportive pilings.

FIG. 3. Is a simplified and partly schematic view of the lefthand side of the lift and safety shut-off apparatus with the safety cable at a position between the two pilings supporting that side of the lift deck.

FIG. 4 is a simplified, partly schematic top view of the safety shut-off apparatus with a person seated on the lift platform and wherein the person's legs extend beyond and below the edge of the lift platform as it is raised.

FIG. 5 is a simplified side view of the safety shut-off apparatus and seated person as shown in FIG. 4 and specifically showing the person sitting on the lift platform with that person's legs engaging the flexible safety cable as the lift platform is being raised to a predetermined height. This exerts upward force and longitudinal tension on the safety cable, which operates the shut-off switch to deactivate the lift operating mechanism and stop further upward movement of the lift platform thereby reducing the risk that the person may be caught between the rising lift platform and the fixed deck and, as a result, suffer serious injury.

FIG. 6 is a schematic view of an alternative shut-off apparatus, which employs a photodetector for sensing the presence of a person or other object on the lift platform at risk of being caught between the fixed deck and the rising lift platform.

### DETAILED DESCRIPTION OF INVENTION

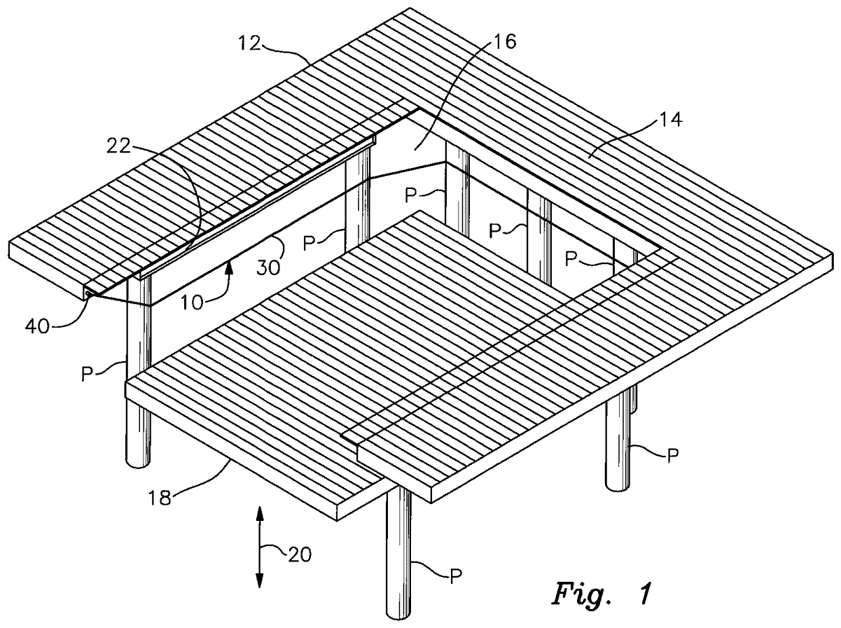

There is shown in FIG. 1 an emergency shut-off apparatus 10 installed on and used in connection with a platform style boat lift 12. The boat lift includes a fixed deck 14 mounted within a body of water and supported by a plurality of pilings P that are secured to and extend upwardly from the bottom of the body of water. Pilings P are sufficiently tall to support deck 14 above the waterline, at least under normal tides, water depths and weather conditions. Deck 14 has a generally planar, horizontal upper surface and may feature various conventional constructions used by docks and other marine platforms. In the version shown in FIG. 1, deck 14 has a generally U-shaped configuration comprising three sides that border a central recess 16.

Platform lift 12 also includes a lift platform 18 that is movably mounted to fixed deck 14 in a manner that allows platform 18 to be raised and lowered relative to fixed deck 14, as indicated by double-headed arrow 20. Platform 18 again includes a generally planar upper surface that largely conforms to recess 16 and the adjacent inside peripheral edge of deck 14. The lift platform is likewise constructed analogously to the surrounding deck in a manner that will be understood to persons skilled in the art. Platform 18 supports a boat or marine vessel on its upper or top surface. As used herein, “boat” encompasses any and all types of boats, watercraft and marine vessels. Various types of supportive structures such as bunks may be carried on the upper surface of platform 18 to stably hold the supported vessel on the lift platform.

Lift platform 18 has a size and configuration that generally conform to the size and shape of recess 16 in deck 14. The platform is supported by the deck and selectively raised and lowered relative to the deck by various conventional drive means not shown in detail in FIG. 1. Such means may include, but are not limited to motor driven winders and lift cables, hydraulic cylinders, gear mechanisms, etc. Indeed, lift 12 may employ virtually any type of lift operating or drive mechanism and other structural components conventionally utilized by platform lifts. In the version disclosed herein, a representative cable driven winder mechanism is illustrated. For clarity, FIG. 1 depicts just the winder housing 22 attached to deck 14. The remaining drawings illustrate the winder and one or more representative lift cables. Nonetheless, various other lift mechanisms may be employed within the scope of this invention. In any case, the operating mechanism is utilized to selectively raise and lower platform 18 between a lowered state below deck 18, wherein the platform is typically immersed in or proximate to the body of water, and an elevated or raised condition wherein the lift platform is received by recess 16 and the upper surface of the platform is substantially level with the upper surface of fixed deck 14. When the lift platform is fully elevated the peripheral edge of platform 18 generally conformably abuts the corresponding edge of deck 14 surrounding recess 16. The corresponding deck and platform edges may interengage or be spaced slightly apart in close proximity. In this condition, the supported boat or other vessel may be conveniently accessed for boarding or departing the vessel and for performing required maintenance tasks on the vessel. Alternatively, the lift mechanism may be operated in a conventional manner to lower platform 18 and the supported boat into the underlying body of water, as shown in FIG. 1. This permits the vessel to be launched from the lowered lift platform. By the same token, lowering the lift platform allows a returning vessel to be reloaded from the water onto the lift platform. The lift platform and supported boat may then be raised so that the upper surface of the platform is generally, if not precisely level with the upper surface of the surrounding fixed deck.

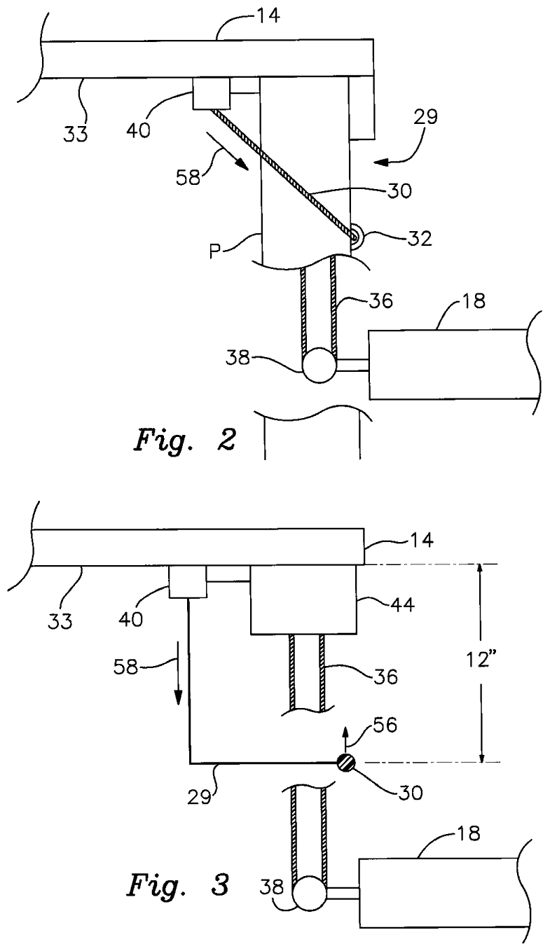

As previously discussed, if a person is sitting on one of the edges of the platform with his or her legs or arms dangling or extending from and edge of the platform, that person faces a serious risk of injury when the lift platform is raised to the level of the deck. The present invention operates to significantly reduce this risk by automatically shutting off the lifting operation to prevent the person's limbs from being accidentally caught and possibly crushed between the rising platform and fixed deck. As shown in FIG. 1 and further described in FIGS. 2-5, lift shut-off apparatus 10 includes a shut-off switch 40 that is connected to deck 14. Apparatus 10 also includes a switch actuating sensor 29 comprising an elongate cable, wire or other type of flexible safety line or element 30, which is secured at each end to a respective end of U-shaped deck 14. Line 30 is connected to and movably engaged with each piling P by a respective anchor 32 that may comprise an eye bolt, O-ring or other means for fastening line 30 to the piling while permitting the line to move longitudinally when a tensioning force is applied to the line. Safety line 30 is positioned to extend below, along and proximate to the inner edge of deck 14 bordering deck recess 16. The flexible safety cable or other line 30 is secured to pilings P such that the line 30 is spaced approximately 12 inches below the bottom 33 of deck 14, although the precise distance is not a limitation of this invention. Flexible line 30 preferably comprises a sturdy but flexible metal cable, wire or other type of strong material (i.e. corded rope, plastic, etc.) capable of withstanding prolonged use in a harsh marine environment and resistant to breakage. It should be understood that various known means may be provided for attaching the cable or other type of flexible line to each of the pilings and to deck 14.

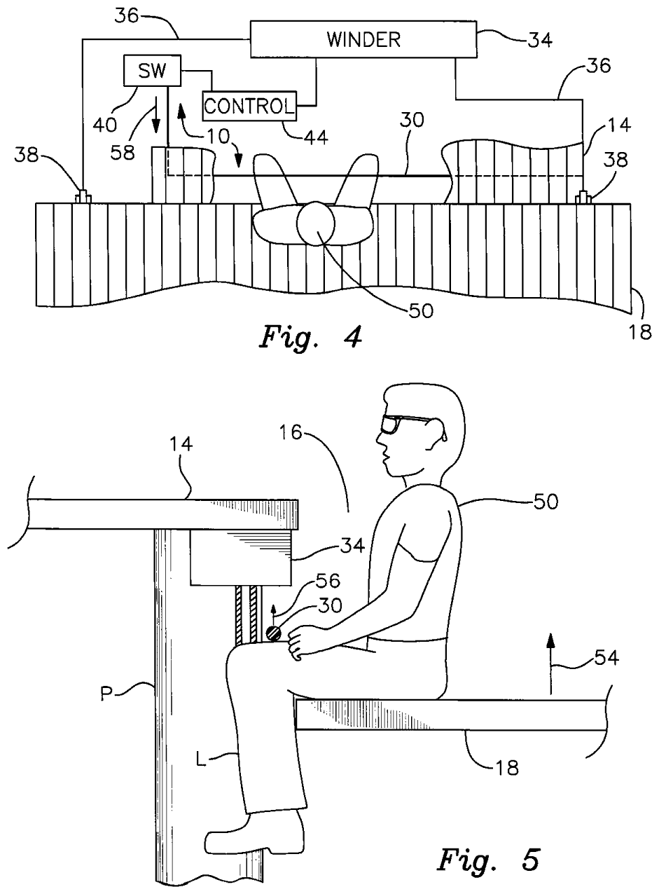

As previously described, the lift mechanism shown in FIGS. 1-5 comprises a standard winder and cable assembly. A winder 34, depicted schematically in FIGS. 4 and 5, is operatively mounted within winder housing 22, FIG. 1. Winder 34 operates one or more lift cables 36, each operatively connected to a corresponding lift pulley 38 supported by lift platform 18. Multiple winders 34 and associated cables 36 and lift pulleys 38 may be similarly interconnected between fixed deck 14 and lift platform 18 at various locations along the opposing sides of the fixed deck and lift platform. The lifting and lowering operation of the representative winder 34, cable 36 and lift pulley 38 described herein will be known to persons skilled in the art.

As represented in FIGS. 1-4, at least one end of safety cable 30 is operably attached to shut-off switch 40, which in turn is mounted to deck 14 by various standard means of attachment. Only one such switch 40 is shown in FIG. 1, although a similar switch may be employed at the opposite side and end of deck 14 located across recess 16, for use in connection with a second opposing winder mechanism (not shown) in the manner described below. Switch 40 may comprise various known types of safety switches suitable for disconnecting power to an operating mechanism when a dangerous condition is sensed. Switch 40 is electrically interconnected to or integrated into a winder control 44, shown schematically in FIGS. 3 and 4. The winder control, which may comprise a drive motor and other conventional electronic components (including, but not limited to lift-mounted, manual switches, remote switches and other circuitry), directs the operation of winder 34 and selectively controls raising and lowering of the lift platform 14.

Emergency shut-off apparatus 10 operates to quickly and automatically stop and limit raising or elevation of lift platform 18 in the following manner. FIGS. 4 and 5 depict a person 50 seated on an edge of platform 18 and facing an abutting inside edge of fixed deck 14 with that person's legs L draped over the edge of platform 18. The lift operates to raise platform 18 in the direction of arrow 54, FIG. 5. If that operation were to continue unabated, person P would be in danger of having his or her legs L caught and possibly crushed between the elevating platform 18 and the fixed deck 14. As discussed above, this could result in a catastrophic injury. Safety shut-off apparatus 10 eliminates this danger. Specifically, when platform 18 elevates to within approximately 12 inches of deck 14, person 50's legs engage sensor cable 30 and push or flex the cable upwardly as shown by arrow 56 in FIG. 3. This upward force exerts a resulting longitudinal tension on cable 30 as indicated by arrows 58, FIGS. 2, 3 and 4. Such tension on the cable pulls and actuates switch 40 so that the switch directs winder control 44 to deactivate and automatically stop further raising operation of winder 34. The lift thereby immediately stops further lifting of platform 18. This prevents person 50's legs from being trapped and compressed between the lift platform and fixed deck. Potentially serious and catastrophic injuries are thereby avoided.

It should be noted that actuation of shut-off switch 40 does not disable the lift operating mechanism from subsequently lowering the lift platform. Such lowering may be performed by selectively actuating the lift's standard manual (lift mounted) and/or remote control switching. In some versions, shut-off switch 40 and winder control 44 may be programmed or connected such that when a person or other obstruction is sensed and the safety shut-off switch is actuated, the motor and winder are directed to automatically reverse direction and lower the lift.

The switch may be normally open or normally closed and wired accordingly within the scope of this invention. In either case, the switch must be actuated to direct the winder control 44 (e.g. motor) and other components of the lift operating mechanism to immediately stop further lifting of the lift platform whenever a predetermined level of upward force and resulting longitudinal tension sufficient to operate safety switch 40 are exerted on the flexible safety line. It should be understood that multiple shut-off switches and associated lift operating mechanisms may be employed within the scope of this invention. By the same token, a single switch and lift controller may be interconnected to and utilized to operate multiple lift mechanisms, particularly when large platforms requiring the use of multiple mechanisms are employed.

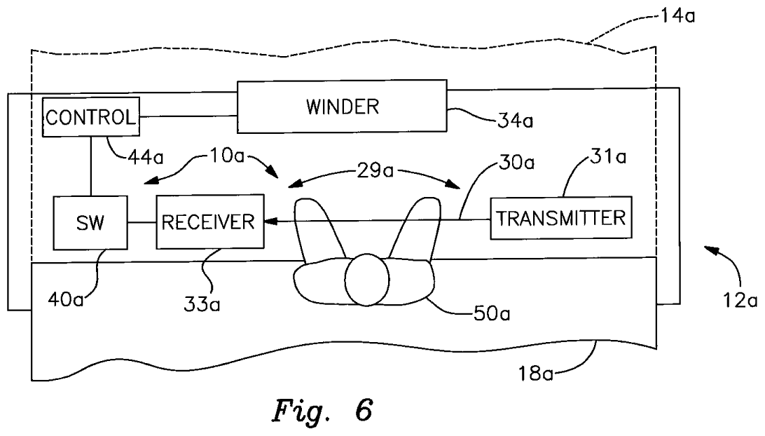

FIG. 6 schematically illustrates an alternative emergency shut-off apparatus 10a for a platform boat lift 12a featuring a fixed deck 14a, shown in phantom for clarity, and an adjoining lift platform 18a analogous to that previously described. Platform 18a is selectively raised and lowered by a lift operating mechanism comprising a motor and/or other winder controls 44a, a winder 34a and other standard components such as lift cables, pulleys, etc (not shown).

In this version, safety shut-off apparatus includes a shut-off switch 40a and a switch actuating sensor 29a comprising a photodetector, electric eye or optical beam sensor (“hereinafter “photodetector”). Various types and wavelengths of light and electromagnetic radiation may be employed by the photodetector within the scope of this invention. Sensor 29a includes a light transmitter 31a and a light receiver 33a that are secured to the bottom of deck 14a or to respective pilings that support the deck above the underlying body of water. Such pilings are not shown in FIG. 6 but are analogous to those shown in the prior embodiment. Transmitter 31a and receiver 33a are positioned and directed such that when they are activated, a sensor light beam 30a is projected from the transmitter to the receiver. The beam extends beneath deck 14a, generally following and proximate to the edge of the deck that abuts a corresponding edge of lift platform 18a when the platform is in a fully elevated condition. Essentially, beam 30a follows a path beneath the deck analogous to the path of flexible cable 30 in the version of FIGS. 1-4.

Optical receiver 33a is functionally connected to shut-off switch 40a such that when beam 30a is detected by receiver 33a, switch 40a remains unactuated. The lift platform can then be operated by its lift operating mechanism (eg winder and winder control) in a conventional manner. However, If a person P is seated on the edge of rising platform 16a and their leg(s) or other body parts extend laterally outwardly from the lift platform and underneath the deck, person P will break or interrupt beam 30a when they reach the predetermined distance below the deck at which the beam is set. The interrupted beam causes optical receiver 33a to produce a signal that actuates shut-off switch 40a to immediately stop the lift mechanism from raising the platform any further. Person P thereby avoids being caught between the lift platform and the deck and potentially suffering severe injury. As in the previously described embodiment, the shut-off switch 40a and winder control 44a are preferably connected and/or programmed so that, in the event that switch 40a is actuated and further elevation of platform 18a is halted, the lift operating mechanism is still able to lower lift platform, either selectively or automatically.

Accordingly, this invention relates to an emergency shut-off device for platform boat lifts. This device effectively and efficiently improves platform lift safety. While this detailed description has set forth particularly preferred embodiments of this invention, numerous modifications and variations of the composition, elements, and steps of this invention, all within the scope of the invention, will readily occur to those skilled in the art. Accordingly, it is understood that this description is illustrative only of the principles of the invention and is not limitative thereof.

Although specific features of the invention are shown in some of the drawings and not others, this is for convenience only, as each feature may be combined with any and all of the other features in accordance with this invention.

1. A safety shut-off apparatus for a platform boat lift, which platform boat lift includes a fixed deck mounted in a body of water, a lift platform operably mounted to the deck, and a lift operating mechanism that selectively raises and lowers the lift platform between an elevated position, wherein the lift platform is substantially level with and abuts the deck, and a lowered position, wherein the lift platform is disposed below the deck, the safety shut-off apparatus comprising:
a safety shut-off switch for attaching to the deck and operably connecting to the lift operating mechanism; and
an elongate switch actuating sensor operably connected to said safety shut-off switch and supported for extending beneath the deck, said switch actuating sensor responding to detection of a predetermined upward force being applied to said switch actuator sensor element when the lift platform is being raised by the lift operating mechanism for actuating said safety shut-off switch such that the lift operating mechanism stops further raising of the lift platform and a top surface of said lift platform is held below and spaced apart from a bottom surface of said deck.

2. The apparatus of claim 1 in which said switch actuating sensor includes a flexible line.

3. The apparatus of claim 2 in which said flexible line includes a cable.

4. The apparatus of claim 1 in which said elongate switch actuating sensor extends substantially horizontally beneath and is spaced apart from the deck such that said safety shut-off switch is actuated and further raising of the lift platform stops before a person on an edge of the lift platform is caught between the deck and the lift platform.

5. A boat platform lift comprising:
a deck fixedly mounted in an underlying body of water;
a lift platform adjacent and operably mounted to said deck for supporting a boat thereon;
a lift operating mechanism that selectively raises and lowers said lift platform between an elevated condition, wherein said lift platform is substantially level with and abuts said deck, and a lowered condition, wherein said lift platform is disposed below said deck,
a safety shut-of switch attached to said deck and operably connected to said lift operating mechanism; and
an elongate switch actuating sensor operably connected to said safety shut-off switch and supported to extend beneath said deck, said elongate switch actuating sensor responding to detection of a predetermined upward force being applied to said switch actuating sensor when said lift platform is being raised by said lift operating mechanism for operating said safety shut-off switch such that said lift operating mechanism stops further raising of said lift platform and said lift platform is held below and spaced apart from said deck.

6. The lift of claim 5 in which said lift platform includes an elongate edge that abuts a corresponding adjacent elongate edge of said deck in said elevated condition and in which at least a section of said elongate switch actuating sensor is supported to extend along and generally follow said adjacent elongate edge of said deck.

7. The lift of claim 6 in which said section of said elongate switch actuating sensor is supported below and spaced apart from said adjacent elongate edge of said deck.

8. The lift of claim 7 in which said elongate edge of said lift platform is held below and spaced apart from said adjacent elongate edge of said deck when said safety shut-off switch is actuated and said lift operating mechanism stops further raising of said lift platform.

9. The lift of claim 8 in which said elongate switch actuating sensor includes a flexible line.

10. The lift of claim 9 in which said elongate switch actuating sensor includes a cable.

11. The lift of claim 8 in which said deck includes a recess for receiving said lift platform such that said corresponding elongate edges of said deck and said platform conformably abut in said elevated condition.

12. The lift of claim 9 in which said deck is supported by pilings mounted in the underlying body of water.

13. The lift of claim 12 in which said flexible line is connected to said pilings such that said flexible line is longitudinally movable relative to said pilings and extends between said pilings beneath said deck and proximate said recess of said deck.

14. The lift of claim 5 in which said lift operating mechanism includes at least one motor-driven winder and a respective lift cable operably connected to said winder.

15. The lift of claim 14 in which said safety shut-off switch is operably connected to a respective said motor-driven winder.

16. The lift of claim 6 in which said safety switch actuating sensor is spaced sufficiently below said deck such that when said safety shut-off switch is actuated and said lift operating mechanism stops further raising of said lift platform, a resulting gap is provided between said deck and said lift platform that is wide enough to prevent a person on said elongate edge of said platform from being caught between said deck and said platform.

17. A safety shut-off apparatus for a platform boat lift, which platform boat lift includes a fixed deck mounted in a body of water, a lift platform operably mounted to the deck, and a lift operating mechanism that selectively raises and lowers the lift platform between an elevated position, wherein the lift platform is substantially level with and abuts the deck, and a lowered position, wherein the lift platform is disposed below the deck, the safety shut-off apparatus comprising:
a safety shut-off switch for attaching to the deck and operably connecting to the lift operating mechanism; and
a switch actuating sensor operably connected to said safety shut-off switch and supported for extending beneath the deck, said switch actuating sensor responding to detection of the presence of an object on the platform that projects laterally outwardly from the platform and underneath the deck when the lift platform is being raised by the lift for actuating said safety shut-off switch such that said lift operating mechanism stops further raising of the lift platform and a top surface of said lift platform is held below and spaced apart from a bottom surface of said deck.

18. The apparatus of claim 17 in which said switch actuating sensor includes a photo detector.

19. The apparatus of claim 18 in which said photodetector includes a transmitter that direct a light beam to a receiver, which receiver is operably connected to said shut-off switch such that when the lift platform is being raised by the lift operating mechanism and the object extending laterally outwardly from the lift platform and underneath the deck interrupts said light beam, said receiver sends a signal for actuating said shut-off switch and stopping further raising of the lift platform.
